(19) United States
(12) Patent Application Publication
(10) Pub. No.: US 2006/0179044 A1
(43) Pub. Date: Aug. 10, 2006

(54) Methods and apparatus for using life-context of a user to improve the organization of documents retrieved in response to a search query from that user

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/315,762

(22) Filed: Dec. 21, 2005

Related U.S. Application Data
(60) Provisional application No. 60/650,430, filed on Feb. 4, 2005.

(51) Int. Cl. G06F 17/30

(52) U.S. Cl. 707/3

(57) ABSTRACT

A computerized method of organizing a set of documents includes receiving a search query from a user; receiving life-context data from the user, the received life-context data identifying at least one life-context from a plurality of predetermined life-contexts in which the user's query was made; identifying a plurality of documents responsive to the search query; assigning a score to each identified document based upon a correlation between life-context usage data for each document and the received life-context data, the life-context usage data describing at least one of a number and frequency of users who have previously accessed the document and who previously accessed the document within the at least one life-context identified within the received life-context data; and organizing the documents based at least in part on the assigned score.

This application claims the benefit of U.S. Provisional Application No. 60/650,430 filed Feb. 4, 2005, which is incorporated in its entirety herein by reference.

### BACKGROUND OF THE INVENTION

1. Field of the Invention

The present invention relates generally to information search and retrieval and, more particularly, to employing usage data to improve information search and retrieval.

2. Discussion of the Related Art

The World Wide Web (“web”) contains a vast amount of information. Locating a desired portion of the information, however, can be challenging. This problem is compounded because the amount of information on the web and the number of new users who are inexperienced at web research is growing rapidly.

People generally surf the web based on its link graph structure, often starting with high quality human-maintained indices or search engines. Human-maintained lists cover popular topics effectively but are subjective, expensive to build and maintain, slow to improve, and do not cover all esoteric topics. Automated search engines, in contrast, locate web sites by matching search terms entered by the user to an indexed corpus of web pages. Generally, the search engine returns a list of web sites sorted based on relevance to the user's search terms. Determining the correct relevance, or importance, of a web page to a user, however, can be a difficult task. For one thing, the importance of a web page to the user is inherently subjective and depends on the user's interests, knowledge, and attitudes.

The problem is further compounded by the fact that the user's search query, usually expressed a simple string of words, does not reflect the life-context under which they desire the search be performed. For example, a user might seek information about solar panels and might initiate a search by entering the keywords “solar panels” into a search engine such as Google or Yahoo. A large list of search results will then be found. To make the search results more useful to the user, the results are ordered, the best results listed first. This ordering is performed using a number of methods, such as ordering the search results based upon the number of times that the string “solar panels” appears in the document. A document that has the string appear a large number of times will be ordered higher on the list than a document that has the string appear a fewer number of times. Unfortunately such ordering methods do not take into account the life-context under which the search was performed. For example, the user might be an engineer seeking technical documentation about solar panels, their intent to find comprehensive and detailed information from a professional technical perspective. On the other hand, the user might be in the process of making a personal investment in a solar panel company, looking for market information and company information and user surveys, information which is sophisticated, but not deeply technical. Or the user might be homeowner looking to price solar panels for their home, wanting information about suppliers and contractors, not professional technical information or professional business information. Or the user might be a parent looking for solar panel information to help his child on a science project. Or the user might be a hobbyist, looking for technical information, but not as sophisticated as the professional engineer or the academic researcher. Or the user might be a middle-school student, looking for basic information for a report he or she is working on at school. In this case, the user likely does not want sophisticated technical information or business information or information about suppliers or information about the latest academic research —the user wants very basic information about solar panels, not too complex, and not too detailed.

What makes the life-context issue even more complex is that very same user might search the very same keyword at different moments in time and thus have very different life-context motivating the search. For example, the same user could at times be looking for professional technical information, at times be looking for professional business information, and at other times be looking for information relevant to his life as a homeowner or hobbyist or parent. What is clearly needed is a means by which a user can perform a search and quickly and clearly indicate the life-context within which the search is being conducted by a user.

Again, conventional methods of determining relevance of retrieved documents are based on matching a user's search terms to terms indexed from web pages. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. Another known method is disclosed in U.S. Patent Application Publication No. 2002/0123988, which is hereby incorporated by reference into this specification.

Each of these conventional methods has shortcomings, however. Term-based methods are biased towards pages whose content or display is carefully chosen towards the given term-based method. Thus, they can be easily manipulated by the designers of the web page. Link-based methods have the problem that relatively new pages have usually fewer hyperlinks pointing to them than older pages, which tends to give a lower score to newer pages. There exists, therefore, a need to develop other techniques for determining the importance of documents with consideration for the life-context within which the search is being performed. Furthermore there exists a need to quickly capture the life-context settings for a user performing a search. Furthermore there exists a need for associating life-context settings with individual web documents and/or groups of web documents such that they can be rapidly ordered when retrieved in a document search.

### SUMMARY OF THE INVENTION

Several embodiments of the invention advantageously address the needs above as well as other needs by providing methods and apparatus for using the life-context of a user to improve the organization of documents retrieved in response to a search query from that user.

In one embodiment, the invention can be characterized as a computerized method of organizing a set of documents that includes receiving a search query from a user; receiving life-context data from the user, the received life-context data identifying at least one life-context from a plurality of predetermined life-contexts in which the user's query was made; identifying a plurality of documents responsive to the search query; assigning a score to each identified document based upon a correlation between life-context usage data for each document and the received life-context data, the life-context usage data describing at least one of a number and frequency of users who have previously accessed the document and who previously accessed the document within the at least one life-context identified within the received life-context data; and organizing the documents based at least in part on the assigned score.

In another embodiment, the invention can be characterized as a computerized method of organizing a set of documents that includes receiving a search query from a user; receiving life-context data from the user, the received life-context data identifying at least one life-context from a plurality of predetermined life-contexts in which the user's query was made; identifying a plurality of documents responsive to the search query; assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context; and organizing the documents based at least in part on the assigned score.

In still another embodiment, the invention can be characterized as an apparatus for organizing a set of documents that includes means for receiving a search query from a user; means for receiving life-context data from the user, the received life-context data identifying at least one life-context from a plurality of predetermined life-contexts in which the user's query was made; means for identifying a plurality of documents responsive to the search query; means for assigning a score to each identified document based upon a correlation between life-context usage data associated with each document and the received life-context data, wherein the life-context usage data describes at least one of a number and frequency of users who have previously accessed the document and who previously accessed the document within the at least one life-context identified within the received life-context data; and means for organizing the documents based at least in part on the assigned score.

In yet another embodiment, the invention can be characterized as an apparatus for organizing a set of documents that includes circuitry having executable instructions; and at least one processor configured to execute the program instructions to perform operations of: receiving a search query from a user; receiving life-context data from the user, the received life-context data identifying at least one life-context from a plurality of predetermined life-contexts in which the user's query was made; identifying a plurality of documents responsive to the search query; assigning a score to each identified document based upon a correlation between life-context usage data associated with each document and the received life-context data, wherein the life-context usage data describes at least one of a number and frequency of users who have previously accessed the document and who previously accessed the document within the at least one life-context identified within the received life-context data; and organizing the documents based at least in part on the assigned score.

In a further embodiment, the invention can be characterized as an apparatus for organizing a set of documents that includes means for receiving a search query from a user; means for receiving life-context data from the user, the received life-context data identifying at least one life-context from a plurality of predetermined life-contexts in which the user's query was made; means for identifying a plurality of documents responsive to the search query; means for assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context; and means for organizing the documents based at least in part on the assigned score.

In another embodiment, the invention can be characterized as an apparatus for organizing a set of documents that includes circuitry having executable instructions; and at least one processor configured to execute the program instructions to perform operations of: receiving a search query from a user; receiving life-context data from the user, the received life-context data identifying at least one life-context from a plurality of predetermined life-contexts in which the user's query was made; identifying a plurality of documents responsive to the search query; assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context; and organizing the documents based at least in part on the assigned score.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram illustrating an exemplary network in which concepts consistent with the present invention may be implemented;

FIG. 2 illustrates a flow diagram, consistent with the invention, for organizing documents based on usage information;

FIG. 3 illustrates a flow chart describing the computation of usage data; and

FIG. 4 depicts an exemplary method, consistent with the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Metaphorically, users wear a variety of different “hats” during his or her life, often wearing multiple different hats during a single day. For example, a user may be wearing a “professional hat” or a “personal hat”, a “technical hat” or an “investor hat”, a “spousal hat” or a “parental hat”, each of these hats representing a life-context for a portion of their lives. For example, when someone is at work and functioning in a business mode, their intents and attitudes are likely very different than when someone is at home functioning in a parental mode. In fact, if that person asks a question verbally when in each of those modes, that question, even if worded exactly the same, usually means different things based on the fundamental life-context within which the question was asked.

Consistent with numerous embodiments of the present invention, methods and apparatus described herein recognize the fact that these different life-contexts exist and that they color the intent of a user when they initiate and conduct an internet search. Therefore, embodiments exemplarily disclosed herein provide methods and apparatus for rapidly determining life-context of a user at the time they perform a search by capturing life-context data and for using that life-context data in the ordering of search results. Furthermore, embodiments exemplarily disclosed herein provide methods and apparatus for associating one or more life-contexts with specific web documents such that those documents can be more effectively ordered with respect to a user's current life-context at the time of a search.

Methods and apparatus disclosed herein identify and use the life-context of a user at the time the user performs a search query. One embodiment exemplarily disclosed herein describes a method of organizing a set of documents by receiving a search query and identifying a plurality of documents responsive to the search query. Each identified document is assigned a score based in whole or in part upon the life-context of the user as well as optionally based in whole or in part upon life-context usage data and/or life-context rating data associated with the document, and the documents are organized based on the assigned scores.

In accordance with another embodiment exemplarily disclosed herein, a search query is received and a list of responsive documents is identified. The list of responsive documents may be based on a comparison between the search query and the contents of the documents, or by other conventional methods. Life-context data relating to the user who is performing the search is also accessed, either by prompting the user to enter such information through a user interface displayed by the user's machine, or from a store of life-context data related to the user and current with respect to the user's present life-context. In one embodiment, for example, the life-context data includes data indicating whether the search is being initiated and conducted with respect to, for example, a professional context or a personal life-context of the user's life. If such data indicates that the user is currently performing the search in a professional life-context, then additional data is included that indicates whether the professional life-context is, for example, a technical context, a business life-context, a vocational life-context, a medical professional context, a legal professional life-context, an educational life-context, a financial life-context, or a media life-context. If, on the other hand, such data indicates that the user is currently performing the search in a personal life-context, then additional data is included that indicates whether the personal life-context is, for example, a consumer life-context, a homeowner life-context, a parental life-context, a medical patient life-context, a patron of the arts life-context, a hobbyist life-context, a social life-context, a family finance life-context, or a general interest life-context. The documents are then organized based in whole or in part on the life-context data relating to the current life-context of the user who has initiated the search.

A. Architecture

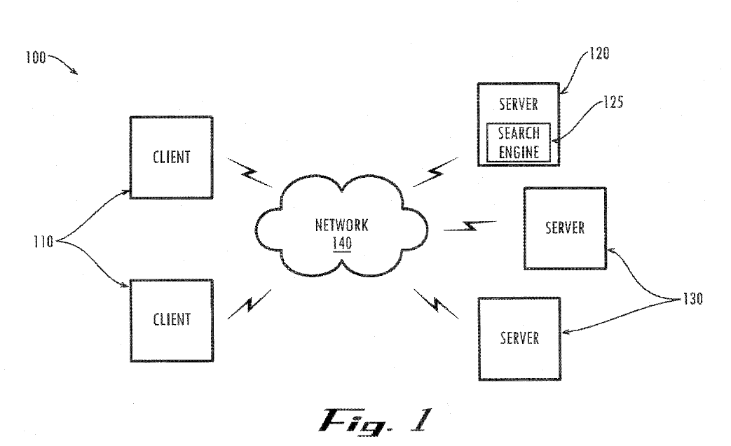

FIG. 1 illustrates an exemplary system 100 in which methods and apparatus consistent with the present invention, may be implemented. The system 100 may include multiple client devices 110 connected to multiple servers 120 and 130 via a network 140. The network 140 may include a local area network (LAN), a wide area network (WAN), a telephone network, such as the Public Switched Telephone Network (PSTN), an intranet, the Internet, or a combination of networks. Two client devices 110 and three servers 120 and 130 have been illustrated as connected to network 140 for simplicity. In practice, there may be more or less client devices and servers. Also, in some instances, a client device may perform the functions of a server and a server may perform the functions of a client device.

The client devices 110 may include devices, such mainframes, minicomputers, personal computers, laptops, personal digital assistants, or the like, capable of connecting to the network 140. The client devices 110 may transmit data over the network 140 or receive data from the network 140 via a wired, wireless, or optical connection.

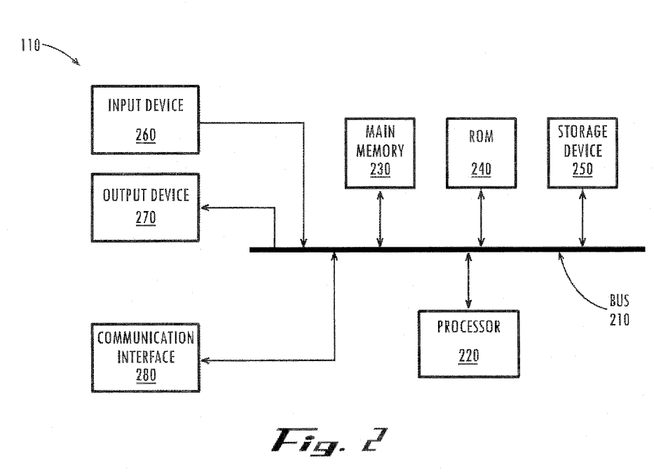

FIG. 2 illustrates an exemplary client device 110 consistent with the present invention.

Referring to FIG. 2, the client device 110 may include a bus 210, a processor 220, a main memory 230, a read only memory (ROM) 240, a storage device 250, an input device 260, an output device 270, and a communication interface 280.

The bus 210 may include one or more conventional buses that permit communication among the components of the client device 110. The processor 220 may include any type of conventional processor or microprocessor that interprets and executes instructions. The main memory 230 may include a random access memory (RAM) or another type of dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive.

The input device 260 may include one or more conventional mechanisms that permit a user to input information to the client device 110, such as a keyboard, a mouse, a pen, voice recognition and/or biometric mechanisms, etc. The output device 270 may include one or more conventional mechanisms that output information to the user, including a display, a printer, a speaker, etc. The communication interface 280 may include any transceiver-like mechanism that enables the client device 110 to communicate with other devices and/or systems. For example, the communication interface 280 may include mechanisms for communicating with another device or system via a network, such as network 140.

As will be described in detail below, the client devices 110, consistent with the present invention, may perform certain document retrieval operations. The client devices 110 may perform these operations in response to processor 220 executing software instructions contained in a computer-readable medium, such as memory 230. A computer-readable medium may be defined as one or more memory devices and/or carrier waves. The software instructions may be read into memory 230 from another computer-readable medium, such as the data storage device 250, or from another device via the communication interface 280. The software instructions contained in memory 230 causes processor 220 to perform search-related activities described below. Alternatively, hardwired circuitry may be used in place of or in combination with software instructions to implement processes consistent with the present invention. Thus, the present invention is not limited to any specific combination of hardware circuitry and software.

The servers 120 and 130 may include one or more types of computer systems, such as a mainframe, minicomputer, or personal computer, capable of connecting to the network 140 to enable servers 120 and 130 to communicate with the client devices 110. In alternative implementations, the servers 120 and 130 may include mechanisms for directly connecting to one or more client devices 110. The servers 120 and 130 may transmit data over network 140 or receive data from the network 140 via a wired, wireless, or optical connection.

The servers may be configured in a manner similar to that described above in reference to FIG. 2 for client device 110. In an implementation consistent with the present invention, the server 120 may include a search engine 125 usable by the client devices 110. The servers 130 may store documents (or web pages) accessible by the client devices 110 and may perform document retrieval and organization operations, as described below.

Other exemplary embodiments of the present invention provide methods and apparatus for storing and processing data related to web page usage, the data referred to generally as usage data. Typically, usage data includes information about a web page that describes how many users visited the page (e.g., over a period of time) and/or how often users visited the page (e.g., over a period of time). As disclosed herein, life-context usage data represents not only how often a particular web page is accessed, but also represents how often a particular web pages is accessed by users who perform the search within a particular life-context. In this way, life-context usage data represents not just how often a web page is accessed, but also how often it is accessed by users that identify themselves as browsing within, for example, a personal life-context and/or how often it is accessed by users that identify themselves as browsing within a professional life-context. In some embodiments, the life-context usage data may represent how often users visit a site while browsing within more specific life-contexts. Accordingly, the life-context usage data may represent how often users visit a particular site while browsing within, for example, a personal parental context, how often users visit a particular site while browsing within a professional medical context, and/or how often users visit a particular site while browsing within a personal homeowner context. Such life-context usage data can then be used to order search results based upon the document's life-context usage data as well as the current life-context data of the user performing the search.

For example, a user who is performing a search of solar panels in a personal homeowner life-context will be given search results that are more highly ordered if they have strong life-context usage data relating to visitors who were browsing in a homeowner life-context and will be given search results that are less highly ordered (i.e. ordered lower on the list) if they instead have strong life-context usage data relating to visitors who were browsing as professional engineers. In this way the user, based upon his current life-context as a personal homeowner, is more likely to be provided with highly ordered search results that are relevant to people browsing as homeowners as opposed to those documents relevant to people browsing as professional engineers. While it might be possible that the homeowner in the example above is also a professional engineer, this does not change the fact that when that user is functioning in a personal life-context as a homeowner he still is more likely to desire documents with strong life-context data relating to homeowners more than he is likely to desire documents with strong life-context data relating to professional engineers.

It should be noted that documents can be ordered with regard to the current life-context of the user performing a search by methods other than through the compilation and comparison of life-context usage data as described above. For example, in addition to or instead of life-context usage data associated with documents retrieved by an internet search, life-context rating data may be associated with documents retrieved by a search.

As described above, life-context usage data is derived based upon the usage numbers and/or usage frequencies of visitors who are browsing a particular document and who are doing so within a particular life-context. Accordingly, when used to order documents, the life-context usage data provides a somewhat indirect measure of the relevance of a document (i.e., the likely appeal of a document) to users who are performing a search within a particular life-context. Life-context rating data, on the other hand, provides a more direct measure of the relevance of a document (i.e., the likely appeal of a document) to users who are performing a search within a particular life-context. Life-context rating data can be assigned to each document and may contain a life-context rating value (e.g., on a scale from 1 to 100) for each life-context supported by the search engine, wherein each life-context rating value describes the relevance that a particular document has with respect to a particular life-context. A high rating value indicates a high likelihood that users searching in a given life-context will find the document appealing and/or useful and a low rating value indicates a low likelihood that users searching in a given life-context will find the document appealing and/or useful. In one embodiment, life-context rating values can be defined, associated with, or otherwise assigned to a given document by a person, such as by the author of the document, the owner of the document, the host of the document, a reviewer who has simply read the document, or some other person. In another embodiment, the life-context rating data can be automatically generated by a computer algorithm that analyzes language components of the document that make it likely to appeal people searching in particular life-contexts. If, as a result of the analyzing, a document is determined to contain a large number or large percentage of first person and second person pronouns, such as “I, me, mine, you, or yours” the algorithm determines that the document is likely to be written in an informal style and more likely to be of interest to users performing searches in a personal life-context. The algorithm will therefore assign to the document a high life-context rating value for personal life-context. On the other hand, if, as a result of the analyzing/identifying, a document is determined contain a small number or small percentage of first and second person pronouns, the algorithm determines that the document is likely to be written in a more formal style and therefore more likely to be of interest to users performing searches in a professional life-context. The algorithm will therefore assign to the document a high life-context rating for professional life-contexts. Other analysis techniques can be used alone or in combination for automatically generating the life-context ratings for a given document, such as analyzing the form and/or frequency of one or more parts of speech, counting the number and/or percentage of pictures, analyzing the average length and/or complexity of sentences, analyzing the frequency and/or form of professional jargon, or analyzing the frequency and/or form of specific professional terms. Whether life-context rating data is manually assigned to a document by a person (e.g., the author of the document) or automatically by a computer algorithm (e.g., an algorithm adapted to analyze the length and complexity of sentences), the life-context rating data can be used to order documents that are retrieved in an internet search.

In one exemplary embodiment, a user performing a search may enter his current life-context by entering data into a user interface, the data indicating, for example, that he is conducting his search in a personal life-context. In another exemplary embodiment, the entered data may indicate that he is conducting his search in his personal capacity as a homeowner (i.e., personal homeowner life-context). To initiate the search, the user generates a search query (e.g., containing the keywords “solar panels”). The search query is received by the search engine software and is used to identify a list of responsive documents. The list of responsive documents may be based on a comparison between the search query and the contents of the documents or by other conventional methods. Next, the responsive documents are ordered and presented to the user, wherein the ordering is based upon a correlation between the life-context usage data and/or life-context rating data of each document and the current life-context of the user who is performing the search. In this example, the current life-context of the user who is performing the search has been entered as a personal homeowner life-context. Therefore, retrieved documents that have life-context usage data and/or life-context rating data with high values for a personal homeowner life-context will be more highly ordered. For example, the ordering algorithm can order documents having high values for personal homeowner life-context based on the value of the life-context usage data and/or life-context rating data. Once those documents are ordered, the ordering algorithm can, for example, order documents that have high values for one or more other similar personal life-contexts (e.g., a personal consumer life-context). Once those documents are ordered, the ordering algorithm can, for example, order documents that have high values for one or more other less similar personal life-contexts (e.g., one or more professional life-contexts).

By determining, storing, and/or accessing life-context usage data and/or life-context rating data for each document as described in the paragraphs above, the methods and systems disclosed herein can be applied to optimize the ordering of search results for a given user. The importance that a user's current life-context has in performing an internet search may vary. For example, some users might consider their current life-context to be a primary factor with which to order search results, while other users might consider their current life-context to be a lesser factor. To accommodate such user differences, an embodiment of the present invention methods and apparatus of the present invention enable a user to provide a life-context significance factor that indicates how much weight his or her life-context data should be given when the search engine orders documents.

B. Architectural Operation

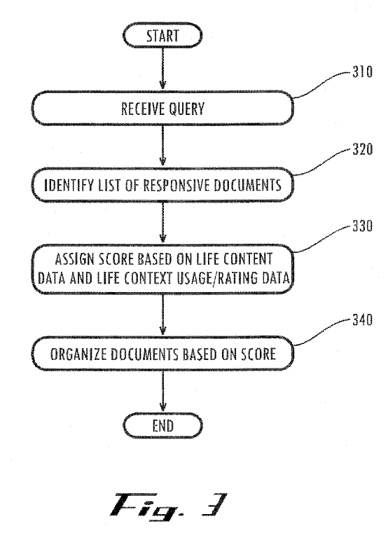

FIG. 3 illustrates an exemplary flow diagram, consistent with the invention, for organizing documents based both on the current life-context data of a user performing a search and life-context usage data and/or life-context rating data related to the web pages that are retrieved during the search.

At stage 310, a search query is received by search engine 125. The query may contain text, audio, video, or graphical information. At stage 320, search engine 125 identifies a list of documents that are responsive (or relevant) to the search query. This identification of responsive documents may be performed in a variety of ways (e.g., comparing the search query to the content of the document).

Once this set of responsive documents has been identified, the documents are organized (i.e., ordered). In one embodiment, the documents may be organized by employing the current life-context data of the user performing the search, in whole or in part. In another embodiment, the documents may be organized by employing life-context usage data and/or life-context rating data of one or more documents retrieved in the search, in whole or in part.

As shown at stage 330, scores are assigned to each document based how well the life-context usage data and/or life-context rating data correlates with the current life-context data of the user who is performing the current search. The scores may be absolute in value or relative to the scores for other documents. For example, a web site having life-context usage data that shows heavy use (i.e. many visits and/or frequent visits) by users who were browsing the document while functioning within a life-context that matches the life-context of the user who initiated the search will receive a high score. The life-context usage data and/or life-context rating data associated with specific documents, and/or the life-context data associated with a user performing a search, may be maintained at client 110 and transmitted to search engine 125 or it could also be maintained in other ways. For example, the data may be maintained at servers 130, which forward the information to search engine 125; or the data may be maintained at server 120 if it provides access to the documents (e.g., as a web proxy).

At stage 340, the responsive documents are organized based on the assigned scores. The documents may be organized based entirely on the scores derived from life-context usage data and/or life-context rating data of the retrieved web pages and the life-context data of the user who has initiated the search. Alternatively, the documents may be organized based on the assigned scores in combination with other factors. For example, the documents may be organized based on the assigned scores combined with link information, query information, and/or other additional information. Link information involves the relationships between linked documents, and an example of the use of such link information is described in the Brin & Page publication referenced above. Query information involves the information provided as part of the search query, which may be used in a variety of ways to determine the relevance of a document. Other additional information may, for example, include the length of the path of a document.

In one implementation, documents may be organized based on a total score that represents the sum, product, or other mathematical combination of a life-context score and a standard query-term-based score (“IR score”).

Many of the methods disclosed herein require that the user identify his or her current life-context during the current web-browsing session and/or the then current web search. Because many browsing sessions conducted by a user begin with or otherwise involve that user performing a search using an internet search engine such as Google or Yahoo, a user can identify his or her current life-context at the time that the search engine is used by the user. In some embodiments, the search engine prompts the user to enter his or her current life-context (i.e., the life-context under which he or she is performing the search) at the time when the user enters a search query into the search engine. In some embodiments, a user enters his or her current life-context by selecting a predetermined general life-context (e.g., a professional life-context or a personal life-context) from within a first user interface. For example, a first user interface presented to the user may enable the user to select a predetermined general life-context (e.g., check a box associated with a professional life-context or check a box associated with a personal life-context). If no predetermined general life-context is selected (e.g., if neither box is checked), then life-context data is not used by the search engine to organize search results. If a predetermined general life-context is selected (e.g., if one of the two boxes is checked), then the search engine can record, save, or otherwise note or identify the predetermined general life-context selected by the user as the then current life-context of the user in the form of life-context data. This life-context data of a user can then be used by the search engine to perform any one or more of the methods disclosed herein.

In some embodiments, once the user has selected a predetermined general life-context (e.g., by checking a box) via the first user interface, the user may be prompted to select one or more specific life-contexts from a set of predetermined specific life-context choices, associated with the selected general life-context, via a second user interface. For example, if the user selected a professional life-context via the first user interface, the second user interface enables the user to select one or more predetermined specific life-contexts from a set of predetermined specific life-contexts associated with a specific instantiation of a professional life-context (e.g., check a box within a list of check boxes, wherein each check box is associated with one of a technical professional context, a business professional context, a vocational professional context, a medical professional context, a legal professional context, an educational professional context, a financial professional context, a media professional context, etc.). If one or more of the boxes is checked, then the search engine can record, save, or otherwise note or identify the then current specific life-context (or contexts) in the form of life-context data. This life-context data can then be used by the search engine to perform any one or more of the life-context related methods disclosed in this patent application.

On the other hand, if the user selected a personal life-context via the first user interface, the second user interface enables the user to select one or more predetermined specific life-contexts from a set of predetermined specific life-contexts associated with a specific instantiation of a personal life-context (e.g., check a box within a list of check boxes, wherein each check box is associated with one of a consumer context, a homeowner context, a parental context, a medical patient context, a patron of the arts context, a hobbyist context, a social context, a family finance context, a general interest context, etc.). If one or more of the boxes is checked, then the search engine can record, save, or otherwise note the then current specific life-context (or contexts) in the form of life-context data. This life-context data can then be used by the search engine to perform any one or more of the life-context related methods disclosed in this patent application.

Once the life-context data of the user is recorded, saved, noted, or otherwise collected or identified (e.g., via a user's interaction with the first and/or second user interfaces, or other suitable means), the search engine can (a) use the user's life-context data to update the life-context usage data associated with documents that the user accesses as a result of the search (either directly from the presented search result list or by following links from documents presented in the search result list), and/or (b) use the user's life-context data (in part or in whole) to order the search result documents presented to this particular user. In this way, collecting life-context data at the time when a user performs a search allows a search engine to better order results for the user who entered the life-context data, and allows the search engine to better order results for future users who enter life-context data by collecting additional life-context usage data associated with the documents accessed by the search.

There are a number of possible techniques for tallying the life-context usage data for a given document. For example, if life-context usage data includes the frequency of visits to a given web site or web document by users who are browsing while functioning within a given life-context, the technique may be as follows: each time a user visits a web document, that user having then current life-context usage data associated with a particular life-context, a life-context count variable correlated to that particular life-context and associated with the given web document is incremented. The life-context count variable can be an absolute or relative number corresponding to the visit frequency of the document, or could be an absolute or relative number corresponding to the number of unique visitors to that document. The variable may be adjusted over time such that it represents the number of times that a document has been visited by users browsing under a particular current life-context in a given period of time (e.g., the past week), or it could represent the change in the number of times that a documents has been visited by such users in a given period of time (e.g., the percent increase during this week compared to the last week), or any number of different ways to measure how many times and/or how frequently a document has been visited by users who are searching and/or browsing while functioning within a particular life-context. A plurality of such life-context count variables may be simultaneously tallied and/or tracked for a particular web document, each of the plurality being associated with a different one of a plurality of different life-contexts. In this way the plurality of life-context count variables that make up the life-context usage data can represent how many times and/or how frequently users functioning within particular life-contexts visit a given web document.

In other implementations, the life-context count variables may be processed using any of a variety of techniques to develop a refined life-context count variable. For example, a refined life-context count variable may be computed by removing certain visits from an associated life-context count variable. For example, one may wish to remove visits by automated agents or by those affiliated with the document at issue, since such visits may be deemed to not represent objective usage. This refined count variable may then be used in the methods disclosed herein.

As mentioned above, life-context usage data represents not only how often a particular web page is accessed, but also represents how often a particular web pages is accessed by users who perform the search within a particular life-context. A number of techniques may be implemented to determine life-context usage data for a document (e.g., a web site). An exemplary technique may, for example, include tallying (e.g., incrementing) a life-context count variable for a document each time a user having visits a web document, wherein the user has a then current life-context usage data associated with a particular life-context, and the life-context count variable is correlated to that particular life-context. The life-context count variable could be an absolute or relative number corresponding to the visit frequency of the document, or could be an absolute or relative number corresponding to the number of unique visitors to that document. The life-context count variable may be adjusted over time such that it represents the number of times that a document has been visited by users browsing under a particular current life-context in a given period of time (e.g. the past week), or it could represent the change in the number of times that a documents has been visited by such users in a given period of time (e.g., the percent increase during this week compared to the last week), or any number of different ways to measure how many times and/or how frequently a document has been visited by users who are searching and/or browsing while functioning within a particular life-context.

A plurality of life-context count variables may be simultaneously tallied and/or tracked for a particular web document, wherein each of the plurality of life-context count variable are associated with a different one of a plurality of different life-contexts. In this way, the plurality of life-context count variables included within the life-context usage data of a document can represent how many times and/or how frequently users functioning within particular life-contexts visit a given document.

In other embodiments, the life-context count variables may be processed using any of a variety of techniques to develop a refined life-context count variable. A refined life-context count variable may be computed by removing certain visits from an associated life-context count variable. For example, one may wish to remove visits by automated agents or by those affiliated with the document at issue, since such visits may be deemed to not represent objective usage. This refined count variable may then be used in the methods disclosed herein.

In addition to tracking how many and/or how often users with a particular current life-context access a given document or site (as described above), embodiments of the present invention disclosed herein may further provide methods adapted to allow the users to rate documents (e.g., websites) by submitting rating information. Accordingly, rating information submitted by a user (i.e., explicit rating information) is correlated with the user's current life-context at the time the user is performing the search. In one embodiment, explicit rating information can optionally be obtained via ratings received from a user when prompted by the search engine (e.g., asking the user to rate the usefulness of the document after it has been reviewed). The rating can be binary (e.g., useful/not-useful) or can be numerical, i.e., given on a continuous rating scale (e.g., a usefulness rating scale from 1 to 10, 1 being the least useful and 10 being the most useful). In this way, a user who is, for example, performing a search in the personal life-context of a hobbyist and who searches for information about solar panels can rate each document he or she reviews, the rating information being added to the life-context usage data and/or life-context rating data store for that document and associated with the life-context of hobbyist.

Using the methods and systems disclosed herein, the life-context usage data and/or life-context rating data correlates the rating information given by the user with that user's then current life-context data. In this way, the life-context usage data and/or life-context rating data stored for the solar panel document in the example above will be updated with the rating information given by the user and correlated with information derived from his current life-context data. For example, if the user had rated the document on a usefulness rating scale from 1 to 10 (with 1 being the least useful and 10 being the most useful) and gave it high usefulness rating 8.5, the life-context usage data and/or life-context rating data will be updated with an indication that the document was found highly useful by a user who was then functioning in his life-context as a hobbyist. Assuming that this same document is accessed by many users who also rate it in this way, the ratings correlated with their then current life-context, the life-context usage data and/or the life-context rating data for that document win provide highly valuable statistical correlations that can be used to order future search results as described by the methods herein.

Embodiments of the present invention disclosed herein may further provide methods adapted to imply a rating for a given document in addition to, or instead of receiving explicit rating information. Accordingly, additional preference data (i.e., implicit rating information derived from the user's actions with respect to a document) can be added to the life-context usage data and/or life-context rating data associated with a given document.

For example, one embodiment of the present invention disclosed herein provides a method adapted to monitor user's local computer to determine whether that user prints a given document that has been received over the internet. If the user has printed some or all of a given document, it can be inferred with a high probability that that user found the document to be important and/or useful. When such a determination is made, the life-context usage data and/or life-context rating data for the given document can be automatically updated with data representing a strong indication of user preference for the document. The life-context usage data and/or life-context rating data can be updated by, for example, automatically assigning a high value on a usefulness rating scale and incorporating the assigned value into the life-context usage data and/or life-context rating data for the given document. Furthermore, the assigned rating, indicating high usefulness, can be correlated with the then current life-context data for the user who has searched for and then printed the document in question.

In practice, some users are more likely to print documents than other users. In fact, some users may print very freely, printing a large percentage of what they retrieve in an internet search, while other users may be very selecting in their printing. To accommodate for such differences in printing habits, an additional embodiment provides a method adapted to track a user's “print ratio”. As used herein, a “print ratio” refers to the number of documents retrieved by a user through an internet search that the user prints (completely or partially) during a given time period (e.g., a month) divided by the total number of documents retrieved by the user through internet searches during that same time period. For example, a first user may have printed 55 documents that were retrieved through internet searches performed on that user's office computer during the last 30 days. During that same 30 day period, that same user may have retrieved and accessed a total of 844 documents. Thus, the print ratio for the first user is 55/844, i.e., 6.5%. A second user might have a print ratio of 122/655, i.e., 18.6%. Based on such information, it can be inferred that the second user is more likely to print documents retrieved off the web than the first user. Hence, the print ratio can be used as a weighting factor to scale the significance (or insignificance) that a given user prints a particular document during a search. A user who has a very low print ratio (e.g., less than 2%) can be deemed as being very unlikely to print documents retrieved from the web. Therefore, when it is recognized that such a user prints a document retrieved from the web, the embodiment described in the previous paragraph can be augmented by assigning a particularly high preference or usefulness value in the life-context usage data and/or life-context rating data associated with the retrieved document. On the other hand, a user who has a very high print ratio (e.g., more than 90%) can be deemed as being very likely to print most documents retrieved off the web. Therefore, when it is recognized that such a user prints a document retrieved off the web, the embodiment described in the previous paragraph can be augmented such that the printing does not result in assigning a particularly high preference or usefulness value in the life-context usage data and/or life-context rating data associated with the retrieved document. Furthermore, the assigned rating, indicating a high or low usefulness, can be correlated with the then current life-context data for the user who has searched for and then printed the document in question.

Embodiments of the present invention disclosed herein may further provide methods adapted to add additional preference data to the life-context usage data and/or life-context rating data stored for a given document, wherein the amount of time that a user spends reviewing that document is monitored. If the user has spent a large amount of time reviewing a given document, it can be inferred with a high probability that that user found the document to be important and/or useful. For example, if the user in the example above who was performing a search in his life context as a homeowner spends 22 minutes reviewing a particular document on solar panels, it is inferred by the software that the document was highly useful to the user. If, on the other hand, this user spent only 2 minutes reviewing a particular document, it can be inferred that the document was not highly useful to the user. Because documents are of varying lengths, it is often more valuable to assess time spent per some unit length of a given document rather than time spent on an entire document. To accommodate varying lengths of documents, an additional embodiment provides a method adapted to compute a “time-length ratio.” As used herein, a “time-length ratio” refers to the amount of time the user spends reviewing a particular document divided by the length of the document. In some embodiments, time spent is measured in seconds and document length is measured in characters. In such embodiments, the time-length ratio is the number of seconds the user spends reviewing the document divided by the number of characters present in the given document. If the document also includes pictures, the picture can be accounted for in document length, wherein the picture is treated as a certain number of characters to be added to the character count. The number of characters that a picture adds to the character count can be a constant (e.g., 400 characters), or it can be scaled based upon the size and/or resolution of the image, wherein a larger and/or higher resolution image is counted as more characters than a smaller and/or lower resolution image.

In practice, users typically read at different rates. To accommodate for such differences in reading proficiency, an additional embodiment provides a method adapted to compute a “normalized time-length ratio.” As used herein, a “normalized time-length ratio” refers to the absolute amount of time a user spends reading a document, normalized using historical data regarding how much time the user typically spends on similar documents, thereby identifying a relative amount of time a user spends reading a document. Accordingly, the normalized time-length ratio can be computed by dividing the aforementioned time-length ratio for a given document with a historical average of time-length ratios that have been generated for that user for other documents. In this way, the normalized time-length ratio can be used as a measure of how much time-per-unit-length the user spends on a current as compared to how much time-per-unit-length the user typically spends on other documents. For example, a user who was searching in his capacity as a homeowner could have a historical average stored for him in memory that indicates he typically spends 21 seconds per 1000 characters present in a given document. When reviewing a current document, it can be determined by software accessing a system clock that he has spent 871 seconds reviewing a document that has 21077 characters. The software may then compute a time-length ratio of 871/21077 and normalize the computed time-length ratio by his historical average of 21/1000, yielding a normalized time-length ratio of 1.97. A normalized time-length ratio of 1.97 means that the user has spent approximately twice as long reviewing the given document as he typically would in his life-context capacity as a homeowner. This normalized time-length ratio is, therefore, an indication that the user likely found the document more useful than most. Had the normalized time-length ratio been computed as a value that was less than 1.0, it would have indicated that the user spent less time reviewing the document than most documents he reviews—an indication that the user likely found the document to be less useful than most. Using the method and system disclosed herein, the normalized time-length ratio can be stored within the life-context usage data and/or life-context rating data for the current document being reviewed and correlated with the then current life-context data of the user who is performing the search. For example, if the user who had retrieved the document above was functioning in his life-context as a homeowner, the life-context usage data and/or life-context rating data store for that document would be updated to include the fact that a user spent about twice his typical time reviewing this document, that user functioning in his life capacity as a homeowner. This life-context usage data and/or life-context rating data could then be used in the future when other users access this particular document, providing valuable statistical correlations, the correlations being used to better order search results as described by the methods herein.

As described in the paragraph above, some embodiments of the present invention make use of a clock (e.g., a system clock on the user's computer), to determine how much time that user spends reviewing a particular document. This time can be computed simply as the elapsed time between the moment the document is opened and the moment the document is closed. While this method can be effective, it is prone to errors. For example, a user might open multiple documents simultaneously and switch back and forth between them. Accordingly, numerous embodiments are herein described that are adapted to derive a more accurate measure of time that a user spends reviewing a particular document. In one such embodiment, the system clock only tallies elapsed time during periods when the document in question is the active window on the user's desktop (assuming a Window's style user interface). In this way, if the user is switching back and forth between multiple documents, only the time during which a given document is the active document is the elapsed time tallied, yielding a more accurate measure. In practice, the above-described embodiment may not account for the fact that the user may give attention to other things not present on his or her computer (e.g., turn to watch television, answer a telephone call, go to the bathroom) or simply take a break, during which time the given document is both opened and active upon the user's desktop. Accordingly, and in another embodiment, the amount of time that a user spends reviewing a particular document is computed by tallying the elapsed time between the document being opened and the document being closed only when the given document is active and also only during times when the user interface device of the system (e.g., the mouse, touchpad, trackball, touch-screen, keyboard, voice recognition system) has not sat idle for more than a given threshold of time. For example, if the user has not generated any detectable input on his mouse, keyboard, touchpad, or other input device for some amount of time more than the time he or she typically takes to review a single screen-full of information, it can be inferred that the user is not actively reviewing that information any more because if he or she was, he or she would likely need to advance the document by scrolling, page advancing, or otherwise interacting with his or her user interface device. For example, the software can be configured to measure through historical averaging that a given user typically spends N seconds to review a screen-full of information. Furthermore, the system can be configured to presume a user is no longer reviewing a document if he or she spends 1.5 N seconds reviewing a document without providing any input to the computer through the mouse, keyboard, or other input device. If that amount of time (i.e., 1.5 N seconds) elapses during which no input is detected, the software tallying the time spent measure for that document will cease tallying. The software will resume tallying once input is received again from the given user through one or more user interface devices. In this way, if a computer is configured with N=60 seconds and the user leaves the computer to answer the phone while in the middle of a document review, talks on the phone for 20 minutes, then returns to continue reviewing the document—the majority of the time elapsed during the 20 minute phone call will not be included in the tally of time spent because the software would determine after 1.5 N (or 90 seconds) that no input was received through the mouse, keyboard, or other interface device, and would cease tallying the elapsed time spent until the user returned and began engaging the mouse, keyboard, or other interface device again.

This last method described in the paragraph above avoids many problems but is still prone to certain errors because a user might review a document and not engage his user interface for a long period of time; not because he has left the document, but because he is reviewing very carefully. To provide an even more accurate measure of time spent, yet another embodiment of the present invention uses a video camera—a common peripheral on many computer systems. The video camera can be suitable configured (e.g., via image processing techniques currently known in the art for head tracking, gesture tracking, eye tracking, and/or user identification) to determine if a user is currently present at the computer or not. Using such a camera and image processing techniques, the methods to measure time spent disclosed in the paragraph above can be augmented with a camera based determination of when a given user leaves his or her computer or turns away from his or her computer screen to focus on other things (e.g., a book, a phone conversation, etc.) as determined by the location and/or direction the user's body, user's head, and/or user's eyes. When the user is determined not to be present at the computer, not to be looking at the computer, or not to be looking at the document in question as displayed upon the computer, the software method that is tallying time spent can cease tallying until the user either returns to the computer, returns his gaze to the computer screen, and/or returns his gaze to the document in question upon the computer screen. In this way, the software can generate a highly accurate measure of time spent by a user reviewing a particular document.

In practice, users often print some or all of a given document and review the hard-copy of the document rather than reviewing the document on the computer. As a result, measures of time spent, obtained as described above, may not be accurate. To accommodate for the possibility of inaccuracies in time spent measures, an additional embodiment provides a software method adapted to identify when a given document is printed and automatically adjust a value of the time spent measure to some high number with the presumption that the user printed the document so that he or she can review the document in substantial detail. Although this presumption may not always be accurate (e.g., the user may have printed the document simply to keep a hardcopy), the fact that the document was printed is very likely an indication that the user found the document to be important and/or useful. Thus, setting the time spent value to some high number (i.e., a number that would produce a high normalized time-length ratio) when it is identified that the user has printed part or all of the given document, may be an effective way of monitoring that a given document is likely of importance and/or useful to the given user.

In accordance with many embodiments of the present invention, the current life-context data associated with a given user can be entered and/or stored in a variety of ways. For example, the current life-context data may be stored in one or more locations including, but not limited to, a client computer (e.g., the user's personal computer, the user's PDA, or the user's cell phone, or the like, or combinations thereof), one or more server machines (e.g., a server associated with the search engine service that the user is accessing, a server associated with the internet service provider the user is using, or the like, or combinations thereof), or the like, or combinations thereof. In all cases, the current life-context data can be stored using any suitable storage technology (e.g., magnetic storage, optical storage, flash memory, RAM, ROM, permanent data storage means, temporary data storage means, or the like, or combinations thereof).

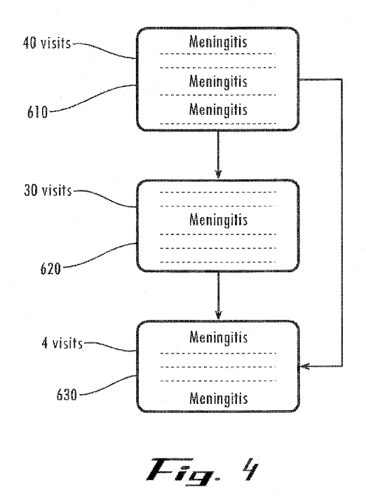

FIG. 4 depicts an exemplary method employing life-context data to order the documents retrieved in an internet search, consistent with the invention.

Referring to FIG. 4, three documents, 610, 620, and 630, are shown which are responsive to a search query for the term “Meningitis”. Document 610 is shown to have been visited 40 times over the past month, with 15 of those 40 visits being by automated agents. Of the 25 non-automated visits, document 610 is shown to have been visited 5 times by users who had current life-context data identifying them as performing their search in their personal life-context as a medical patient, visited by 18 times by users who had current life-context data identifying them as performing their search in a medical professional life-context, and visited by 2 users who had current life-context data identifying them as performing their search in a personal general interest life-context. Document 620, which is linked to document 610, is shown to have been visited 30 times over the past month. Of the 30 visits, document 620 is shown to have been visited 24 times by users who had current life-context data identifying them as performing their search in their personal life-context of medical patient, visited by 5 times by users who had current life-context data identifying them as performing their search in a medical professional life-context, and visited by 1 users who had current life-context data identifying them as performing their search in a personal general interest life-context. Document 630, which is linked to documents 610 and 620, is shown to have been visited 4 times over the past month. Of the 4 visits, this document is shown to have been visited 0 times by users who had current life-context data identifying them as performing their search in their personal medical patient life-context, visited by 0 times by users who had current life-context data identifying them as performing their search in a medical professional life-context, and visited by 4 users who had current life-context data identifying them as performing their search in a personal general interest life-context.

Under a conventional term frequency based search method, the documents are organized based on the frequency with which the search query term (“meningitis”) appears in the document. Accordingly, the documents are organized into the following order: document 620 (assuming three occurrences of “meningitis” were found), document 630 (assuming two occurrences of “meningitis” were found), and document 610 (assuming one occurrence of “meningitis” was found).

Under a conventional link-based search method, the documents are organized based on the number of other documents that link to those documents. Accordingly, the documents may be organized into the following order: 630 (linked to by two other documents), 620 (linked to by one other document), and 610 (linked to by no other documents).

Methods and apparatus consistent with the invention employ the life-context data of the user performing the search as well as life-context usage data and/or life-context rating data for one or more of the documents retrieved, to aid in organizing documents. For example, by reviewing the current life-context data of the user who is performing the search, the user is currently searching in his personal life-context as a medical patient. The documents may then be organized not based simply upon the number of visits, the number of non-automated visits, or the distribution of visits from various IP addresses locations, but upon the specific current life-context under which the user is currently performing the search. In this case the personal life-context of the user is as a medical patient, so that life-context is used as the primary ordering metric. The documents are then ordered such that the documents listed first are those that have the highest number of recent visits from users who were searching and/or browsing while also functioning in a personal life-context as a medical patient. Using the medical patient life-context as the ordering metric, the documents were organized in the following order: document 620 (24 visits from users who were functioning in a personal life-context as a medical patient) document 610 (5 visits from users who were functioning in a personal life-context as a medical patient), and document 630 (0 visits from users who were functioning in a personal life-context as a medical patient). In this way, a user who is searching from the perspective of a medical patient is presented with search results ordered such that the documents listed first are most likely relevant to medical patients as apposed to those documents that might be more relevant to professional medical practitioners (as would have been the case if the documents were ordered simply on the frequency of keyword appearances in the document and/or total number of visits).

In some embodiments, multiple factors may be used to order documents, including traditional factors that are used in combination with the novel factors disclosed herein. For example the life-context data, the life-context usage data, and/or life-context rating data, may be used in combination with overall usage statistics, keyword match statistics, and/or link information to develop the ultimate organization of the documents.

While the invention herein disclosed has been described by means of specific embodiments, examples and applications thereof, numerous modifications and variations could be made thereto by those skilled in the art without departing from the scope of the invention set forth in the claims.

What is claimed is:

1. A computerized method of organizing a set of documents, comprising:
receiving a search query from a user;
receiving life-context data from the user, the received life-context data identifying at least one life-context from a plurality of predetermined life-contexts in which the user's query was made;
identifying a plurality of documents responsive to the search query;
assigning a score to each identified document based upon a correlation between life-context usage data for each document and the received life-context data, the life-context usage data describing at least one of a number and frequency of users who have previously accessed the document and who previously accessed the document within the at least one life-context identified within the received life-context data; and
organizing the documents based at least in part on the assigned score.

2. The computerized method of claim 1, wherein the step of receiving the life-context data includes accessing life-context data from a client computer.

3. The computerized method of claim 1, wherein the step of receiving the life-context data includes accessing life-context data from a server machine.

4. The computerized method of claim 1, further comprising:
presenting a user interface to the user, the first user interface comprising a plurality of predetermined life-contexts selectable by the user, wherein
the step of receiving the life-context data includes:
identifying each predetermined life-context selected by the user as the life-context data.

5. The computerized method of claim 1, further comprising:
presenting a first user interface to the user, the first user interface comprising a plurality of predetermined general life-contexts selectable by the user,
identifying a predetermined general life-context selected by the user; and
presenting a second user interface to the user, the second user interface comprising a plurality of predetermined specific life-contexts associated with the identified general life-context and selectable by the user, wherein
the step of receiving the life-context data includes:
identifying each predetermined specific life-context selected by the user as the life-context data.

6. The computerized method of claim 5, wherein the plurality of predetermined general life-contexts include a personal life-context and a professional life-context.

7. The computerized method of claim 6, wherein the plurality of predetermined specific life-contexts associated with the personal life-context include at least two of a consumer life-context, a homeowner life-context, a parental life-context, a medical patient life-context, a patron of the arts life-context, a hobbyist life-context, a social life-context, a family finance life-context, and a general interest life-context.

8. The computerized method of claim 6, wherein the plurality of predetermined specific life-contexts associated with the professional life-context include at least two of a technical context, a business life-context, a vocational life-context, a medical professional context, a legal professional life-context, an educational life-context, a financial life-context, or a media life-context.

9. The computerized method of claim 1, further comprising receiving a life-context significance factor from the user, the life-context significance factor indicating how much weight to give the received life-context data in the step of assigning the score.

10. The computerized method of claim 1, further comprising assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context.

11. The computerized method of claim 10, further comprising receiving a life-context rating value that has been manually assigned to a document.

12. The computerized method of claim 11, wherein the step of receiving a manually assigned life-context rating value includes receiving a life-context rating value from at least one of an author of the document, an owner of the document, a host of the document, or a person that has previously reviewed the document.

13. The computerized method of claim 10, further comprising automatically assigning a life-context rating value to a document.

14. The computerized method of claim 13, wherein the step of automatically assigning a life-context rating value includes at least one of analyzing language components of the document, analyzing at least one of the form and frequency parts of speech within the document, counting at least one of number and percentage of pictures within the document, analyzing at least one of the average length and complexity of sentences within the document, analyzing at least one of the frequency and form of professional jargon with in the document, and analyzing at least one of the frequency and form of specific professional terms within the document.

15. The computerized method of claim 1, further comprising:
correlating the life-context usage data for each identified document with rating information for that document, the rating information indicating a level of usefulness of the identified document to one or more previous users who accessed the document within the at least one life-context identified within the received life-context data,
the step of assigning a score to each identified document includes:
assigning a score to each identified document based upon the correlation between the rating information for each document and the received life-context data.

16. The computerized method of claim 15, wherein the rating information is identified as a binary or numerical value.

17. The computerized method of claim 15, further comprising receiving rating information from the user.

18. The computerized method of claim 15, further comprising deriving rating information from the user's actions.

19. The computerized method of claim 18, wherein the step of deriving rating information includes:
determining whether the user prints a document; and
generating the rating information when it is determined that the user prints the document.

20. The computerized method of claim 18, wherein the step of deriving rating information includes:
determining an amount of time the user spends reviewing a document; and
generating the rating information based on the determined amount of time.

21. The computerized method of claim 18, wherein the step of deriving rating information includes:
determining an amount of time the user spends reviewing a document;
determining whether the user prints the document; and
generating the rating information based on the determined amount of time and when it is determined that the user prints the document.

22. A computerized method of organizing a set of documents, comprising:
receiving a search query from a user;
receiving life-context data from the user, the received life-context data identifying at least one life-context from a plurality of predetermined life-contexts in which the user's query was made;
identifying a plurality of documents responsive to the search query;
assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context; and
organizing the documents based at least in part on the assigned score.

23. The computerized method of claim 22, wherein the step of receiving the life-context data includes accessing life-context data from a client computer.

24. The computerized method of claim 22, wherein the step of receiving the life-context data includes accessing life-context data from a server machine.

25. The computerized method of claim 22, further comprising:
presenting a user interface to the user, the first user interface comprising a plurality of predetermined life-contexts selectable by the user, wherein
the step of receiving the life-context data includes:
identifying each predetermined life-context selected by the user as the life-context data.

26. The computerized method of claim 22, further comprising:
presenting a first user interface to the user, the first user interface comprising a plurality of predetermined general life-contexts selectable by the user,
identifying a predetermined general life-context selected by the user; and
presenting a second user interface to the user, the second user interface comprising a plurality of predetermined specific life-contexts associated with the identified general life-context and selectable by the user, wherein
the step of receiving the life-context data includes:
identifying each predetermined specific life-context selected by the user as the life-context data.

27. The computerized method of claim 26, wherein the plurality of predetermined general life-contexts include a personal life-context and a professional life-context.

28. The computerized method of claim 27, wherein the plurality of predetermined specific life-contexts associated with the personal life-context include at least two of a consumer life-context, a homeowner life-context, a parental life-context, a medical patient life-context, a patron of the arts life-context, a hobbyist life-context, a social life-context, a family finance life-context, and a general interest life-context.

29. The computerized method of claim 27, wherein the plurality of predetermined specific life-contexts associated with the professional life-context include at least two of a technical context, a business life-context, a vocational life-context, a medical professional context, a legal professional life-context, an educational life-context, a financial life-context, or a media life-context.

30. The computerized method of claim 22, further comprising receiving a life-context significance factor from the user, the life-context significance factor indicating how much weight to give the received life-context data in the step of assigning the score.

31. The computerized method of claim 22, further comprising assigning a score to each identified document based upon a correlation between life-context usage data associated with each document and the received life-context data, wherein the life-context usage data describes at least one of a number and frequency of users who have previously accessed the document and who previously accessed the document within the at least one life-context identified within the received life-context data.

32. The computerized method of claim 22, further comprising receiving a life-context rating value that has been manually assigned to a document.

33. The computerized method of claim 32, wherein the step of receiving a manually assigned life-context rating value includes receiving a life-context rating value from at least one of an author of the document, an owner of the document, a host of the document, or a person that has previously reviewed the document.

34. The computerized method of claim 22, further comprising automatically assigning a life-context rating value to a document.

35. The computerized method of claim 34, wherein the step of automatically assigning a life-context rating value includes at least one of analyzing language components of the document, analyzing at least one of the form and frequency parts of speech within the document, counting at least one of number and percentage of pictures within the document, analyzing at least one of the average length and complexity of sentences within the document, analyzing at least one of the frequency and form of professional jargon with in the document, and analyzing at least one of the frequency and form of specific professional terms within the document.

36. The computerized method of claim 22, further comprising:
correlating the life-context rating data for each identified document with rating information for that document, the rating information indicating a level of usefulness of the identified document to one or more previous users who accessed the document within the at least one life-context identified within the received life-context data,
the step of assigning a score to each identified document includes:
assigning a score to each identified document based upon the correlation between the rating information for each document and the received life-context data.

37. The computerized method of claim 36, wherein the rating information is identified as a binary or numerical value.

38. The computerized method of claim 36, further comprising receiving rating information from the user.

39. The computerized method of claim 36, further comprising deriving rating information from the user's actions.

40. The computerized method of claim 39, wherein the step of deriving rating information includes:
determining whether the user prints a document; and
generating the rating information when it is determined that the user prints the document.

41. The computerized method of claim 39, wherein the step of deriving rating information includes:
determining an amount of time the user spends reviewing a document; and
generating the rating information based on the determined amount of time.

42. The computerized method of claim 39, wherein the step of deriving rating information includes:
determining an amount of time the user spends reviewing a document;
determining whether the user prints the document; and
generating the rating information based on the determined amount of time and when it is determined that the user prints the document.

43. An apparatus for organizing a set of documents, comprising:
means for receiving a search query from a user;
means for receiving life-context data from the user, the received life-context data identifying at least one life-context from a plurality of predetermined life-contexts in which the user's query was made;
means for identifying a plurality of documents responsive to the search query;
means for assigning a score to each identified document based upon a correlation between life-context usage data associated with each document and the received life-context data, wherein the life-context usage data describes at least one of a number and frequency of users who have previously accessed the document and who previously accessed the document within the at least one life-context identified within the received life-context data; and
means for organizing the documents based at least in part on the assigned score.

44. An apparatus for organizing a set of documents, comprising:
circuitry having executable instructions; and
at least one processor configured to execute the program instructions to perform operations of:
receiving a search query from a user;
receiving life-context data from the user, the received life-context data identifying at least one life-context from a plurality of predetermined life-contexts in which the user's query was made;
identifying a plurality of documents responsive to the search query;
assigning a score to each identified document based upon a correlation between life-context usage data associated with each document and the received life-context data, wherein the life-context usage data describes at least one of a number and frequency of users who have previously accessed the document and who previously accessed the document within the at least one life-context identified within the received life-context data; and
organizing the documents based at least in part on the assigned score.

45. An apparatus for organizing a set of documents, comprising:
means for receiving a search query from a user;
means for receiving life-context data from the user, the received life-context data identifying at least one life-context from a plurality of predetermined life-contexts in which the user's query was made;
means for identifying a plurality of documents responsive to the search query;
means for assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context; and
means for organizing the documents based at least in part on the assigned score.

46. An apparatus for organizing a set of documents, comprising:
circuitry having executable instructions; and
at least one processor configured to execute the program instructions to perform operations of:
receiving a search query from a user;
receiving life-context data from the user, the received life-context data identifying at least one life-context from a plurality of predetermined life-contexts in which the user's query was made;
identifying a plurality of documents responsive to the search query;
assigning a score to each identified document based upon a correlation between life-context rating data associated with each document and the received life-context data, the life-context rating data including a life-context rating value associated with one of the plurality of predetermined life-contexts and describing the relevance of the associated document with respect to the associated life-context; and
organizing the documents based at least in part on the assigned score.
